(19) United States
(12) Patent Application Publication
(10) Pub. No.: US 2009/0037887 A1
(43) Pub. Date: Feb. 5, 2009

(54) Compiler-inserted predicated tracing

(76) Inventor: Shasank K. Chavan, Cupertino, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/888,235

(22) Filed: Jul. 30, 2007

(51) Int. Cl. G06F 9/44

(52) U.S. Cl. 717/128

(57) ABSTRACT

One embodiment relates to a computer-implemented method of generating an executable program which includes inserting predicated calls to trace routines during compilation of the source code. Each predicated call comprises a function call that is conditional upon a value stored in a predicate register. The object code generated from compiling said source code is subsequently linked with object code which includes the trace routines. Another embodiment relates to a computer-implemented method of executing a deployed computer program with low-level tracing using compiler-inserted predicated tracing calls. A tracing mode is enabled by setting one or more predicate register bits in a microprocessor. Predicated calls to trace routines insert trace data into at least one trace buffer. Upon a system crash, a core file including said trace data is written out. Other embodiments, aspects and features are also disclosed.

### BACKGROUND OF THE INVENTION

1. Field of the Invention

The present invention relates generally to computer systems and software.

2. Description of the Background Art

After being developed, debugged, and released, software products are deployed at customer sites. Unfortunately, although previously debugged during development, deployed software still often experiences failures.

When deployed software fails at a customer site, usually only a “core dump” or “core file” is available. A core file typically includes a record of the contents of working memory at the time a process is aborted by certain types of internal errors. The core file may be used by the software vendor in an attempt to determine a root cause of the failure. From the dump information, the failing instruction may be determined.

A person may try to find the path leading to the root cause by “walking backwards” from the failing instruction. In other words, a low-level debugging session (where a failure is analyzed at the assembly language level by reviewing instructions one by one) begins with the failing instruction. In order to understand how that instruction came to fail, it is generally helpful to see what instructions were executed before it. Without a trace, one would need to examine the instructions one by one to determine the path to the failing instruction, reading register values, interpreting instructions, and so on. Unfortunately, this process is often extremely difficult and time consuming, especially considering that deployed code is usually optimized and so more difficult to understand.

Note that, in addition to the failing instruction, the core file typically also includes a stack trace showing the chain of routines called. The stack trace provides a high-level trace, but the stack trace is static. By static it is meant that, if the stack trace shows routine A which called routine B which called routine C which is where the failure occurred, then if for some reason routine B called D and then routine D returned control back to routine B, no where in the stack trace does it show that D was called. That information requires dynamic tracing.

Trace data provides a record of the execution flow of a program. Having trace data is often very helpful in determining a root cause of a failure event because a trace shows the execution path taken to the failing instruction. Unfortunately, there are several problems and obstacles to having deployed software provide such trace data.

A first obstacle is that the mechanism to enable tracing needs to be easy to implement. This is because substantially delaying software deployment in order to embed the tracing code would be very costly for a business.

A second obstacle is that the mechanism to enable tracing should be fast and easy to use. Having to stop and then restart the application with tracing enabled in order to use the tracing feature would also be undesirable from a business perspective.

A third obstacle is that the tracing support should impose low overhead on the normal execution of the software. In other words, if the deployed application has tracing code embedded in it, there should be negligible performance impact if the tracing is disabled.

A fourth obstacle is that the tracing calls should be inserted throughout a large portion of a program. This is desirable to ensure sufficient coverage for low-level debugging in which a failure is analyzed at the assembly language level.

Previously, most software developers manually insert trace calls in their source code and “guard” the trace calls with conditional compilation flags or programmatic control. However, manual insertion is laborious, and often times inadequate, since not enough calls may be placed in enough locations to help triage low-level bugs. Furthermore, conditional compilation is undesirable because it requires redeployment of the application to enable tracing. Controlling tracing programmatically does not have this drawback, but the explicit inclusion of trace calls in the source code limits compiler optimizations. Moreover, the checking overhead executed for each trace call, regardless of whether tracing is enabled or not, is too expensive in terms of performance.

Binary instrumentation techniques, such as the ATOM toolkit for Tru64 UNIX, allows one to automatically insert tracing calls directly into generated object files. However, these techniques are also unsatisfactory because they generally require the instrumented application to be constructed off-line and then redeployed for use.

DTRACE is a dynamic tracing facility provided by Sun Microsystems. Applicant believes that DTRACE has its instrumentation, probe processing, and buffering done in the operating system kernel. Applicant further believes that tracing user-level processes with DTRACE is undesirably expensive performance-wise because a trap occurs at every instrumentation point in order for the kernel to gain access and collect the trace.

Other techniques may provide trace data which is only a few to several entries deep, not enough for low-level debugging of a core file, and/or may be sampling based. Sampling-based techniques are not well suited for low-level debugging.

### BRIEF DESCRIPTION OF THE DRAWINGS

FIG. 1 is a schematic diagram depicting a system for generating computer-executable program code having capability for compiler-inserted predicated tracing in accordance with an embodiment of the invention.

FIG. 2A is a schematic diagram depicting a method for performing compiler-inserted predicated tracing with a trace buffer in the data section of a process in accordance with an embodiment of the invention.

FIG. 2B is a schematic diagram depicting a trace buffer in global memory in accordance with an embodiment of the invention.

FIG. 2C is a schematic diagram depicting a trace buffer in each activation record in accordance with an embodiment of the invention.

FIG. 3 depicts a high-level view of example program code before and after insertion of instrumentation for predicated trace calls in accordance with an embodiment of the invention.

FIG. 4A depicts predicated call insertion by replacing a no operation (nop) instruction in a branch slot in accordance with an embodiment of the invention.

FIG. 4B depicts moving instructions around to create a nop branch slot for predicated trace call insertion in accordance with an embodiment of the invention.

FIG. 4C depicts inserting a predicated trace call in a new bundle in accordance with an embodiment of the invention.

FIG. 5 is a schematic diagram of an example computer system or apparatus which may be used to execute the computer-implemented procedures in accordance with an embodiment of the invention.

### DETAILED DESCRIPTION

The present application discloses methods and apparatus which address the above-discussed obstacles and problems to having deployed software provide trace data in an effective and efficient manner. The disclosed methods and apparatus greatly facilitate tracing deployed system software for the purposes of low-level debugging and/or system monitoring.

In accordance with an embodiment of the invention, a software instrumentation solution is disclosed. The solution is generally referred to herein as “predicated tracing.” In predicated tracing, the compiler is used to automatically insert predicated calls to trace routines into software targeted for deployment.

A hardware register stores data which may be readily accessed by a central processing unit (CPU) of a computer as it executes instructions. A hardware predicate register stores data for use in controlling the execution of predicated instructions. For example, a one-bit predicate register may control conditional execution of instructions or conditional branches.

A predicated call is a function call instruction that is “guarded” by a hardware predicate register. This means that if the predicate register is enabled, the call is performed. Otherwise, the call instruction is treated as a no operation (no-op or nop) instruction. For example, if the one-bit predicate register has a one (TRUE) value stored therein, then the predicated call is performed. On the other hand, if the one-bit predicate register has a zero (FALSE) value stored therein, then the predicated call is not performed and is instead treated as a nop instruction.

In accordance with an embodiment of the invention, predicated tracing may be implemented to take advantage of a microprocessor with a relatively large set of predicate registers. Such a relatively large set of predicate registers allows for one or two predicate registers to be dedicated for the purpose of predicated tracing while still having many other predicate registers for use in generating optimal code. For example, an Itanium™ microprocessor by Intel Corporation of Santa Clara, Calif. includes sixty-four one-bit predicate registers and seven branch registers. Applicants have tested predicated tracing on such an Itanium™ microprocessor. The results indicate that having exclusive use to a few caller-preserved variants of these registers for predicated tracing has little or negligible impact on the performance of the generated code when tracing is disabled. In other words, deployed software instrumented with predicated trace calls exhibited negligible probe effect when tracing is disabled; that is, the programs performed as normally as they would have if the predicated tracing calls were not present.

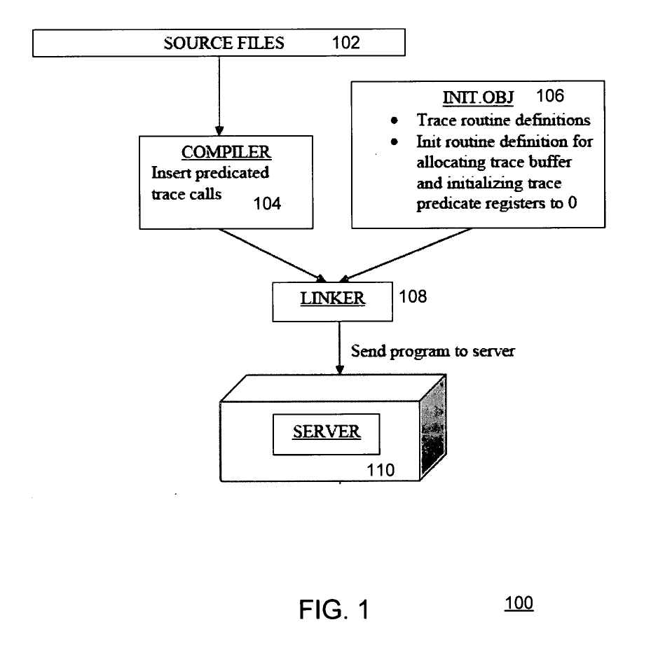

FIG. 1 is a schematic diagram depicting a system 100 for generating computer-executable program code having capability for compiler-inserted predicated tracing in accordance with an embodiment of the invention. As shown, source files 102 for the program are input to a compiler 104.

The compiler 104 may be configured to insert the predicated trace calls. In accordance with a preferred embodiment, the predicated trace calls may be inserted after performance of compiler optimizations. Because compiler transformations are generally limited across function call boundaries, expected code generation may be maintained by applying the insertion phase after all compiler optimizations have completed. In other words, the predicated trace calls may be inserted after the compiler optimizes the code without substantially disrupting the effectiveness of those optimizations.

The linker 108 links together object files generated by the compiler with other object files so as to create an executable file of the program. The other object files may include, for example, an “INIT.OBJ” file 106. The INIT.OBJ file may be configured to include trace routine definitions. The INIT.OBJ file may also be configured with an initialization routine definition for allocating a trace buffer and initializing trace predicate registers (those predicate registers dedicated for use in predicate tracing) to zero, for example. The executable file of the program may then be sent from the linker 108 to a server 110. In otherwords, the software application may then be deployed.

More particularly, the compiler 104 may be configured to insert a predicated call to enter a trace monitor procedure (designated, for example, “TRACE_FUNCTION_ENTRY( )”) at a desired entry point of a function. Similarly, the compiler 104 may be configured to enter a trace monitor procedure (designated, for example, “TRACE_FUNCTION_EXIT( )”) at a desired exit point of a function. In other words, TRACE_FUNCTION_ENTRY and TRACE_FUNCTION_EXIT are used for the purposes of tracing those functions that were called dynamically during the execution of the program.

Furthermore, the compiler 104 may be configured to insert a predicated call to a trace debug procedure (named, for example, “TRACE_DEBUG( )”) at various control flow decision points in the program. Control flow decision points are “split points” in the control flow graph of the program (i.e. logic points where decisions are made), where control either “falls-through” to the immediately following instructions or branches to another block of instructions. A control flow graph shows in graph form the paths that might be traversed through a program during its execution. The placement of these predicated trace calls preferably provides sufficient coverage for debugging and/or monitoring purposes.

For example, when implemented in an Itanium™ processor, the predicated trace calls themselves may be encoded using a single Itanium™ instruction with a guarding predicate register. TRACE_DEBUG calls may be implemented to be guarded by the predicate register p2, for example, and may look like: (p2) br.call b7=TRACE_DEBUG. TRACE_FUNCTION_ENTRY and TRACE_FUNCTION_EXIT calls may be implemented similarly, except that they are to be guarded by a different predicate register, for example, the predicate register p3. In this example implementation, branch register b7 in the Itanium™ processor may be used exclusively for predicated calls.

Advantageously, because the Itanium™ architecture (“IA64”) allows instructions to be executed in parallel, the performance cost of adding the predicated call is typically very low, and often times zero. In accordance with an embodiment of the invention, what often happens is that a nop slot is found by the compiler in an IA64 bundle of instructions, and the nop slot is replaced with a predicated trace call. Because nops are typically more abundant on IA64 systems than in others, they are relatively easy to find. Calculations may be made to ensure that program correctness is maintained when the nop is replaced with the predicated call.

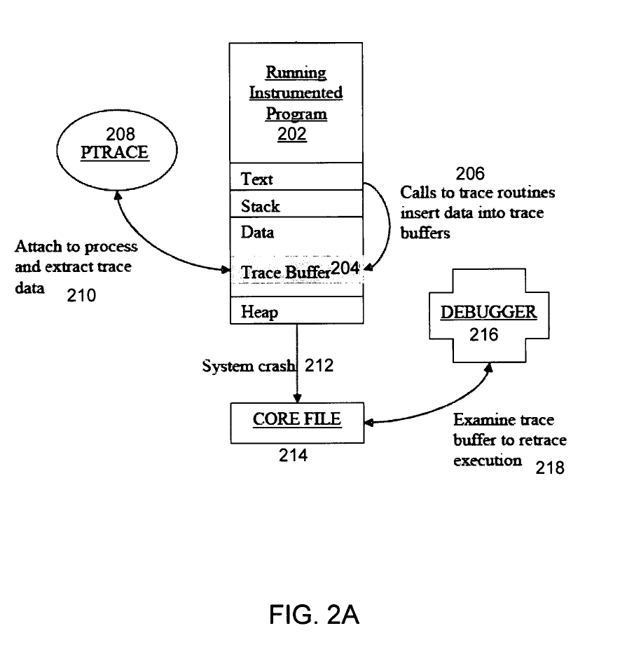

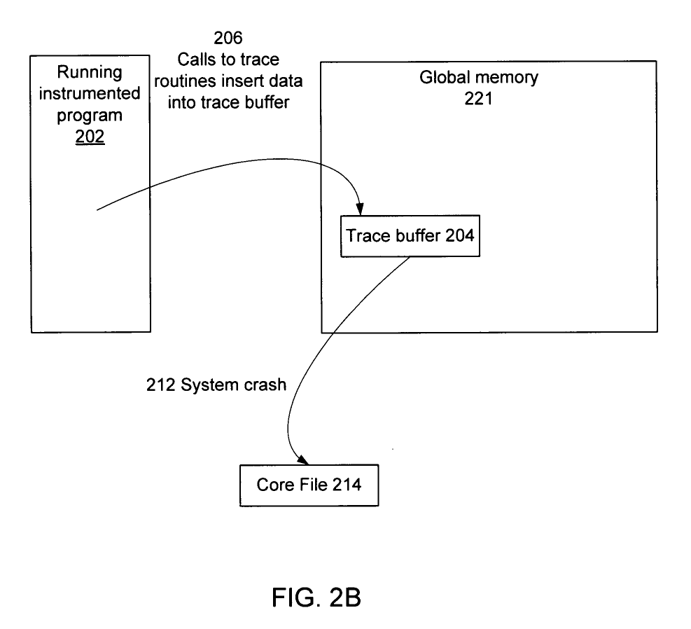

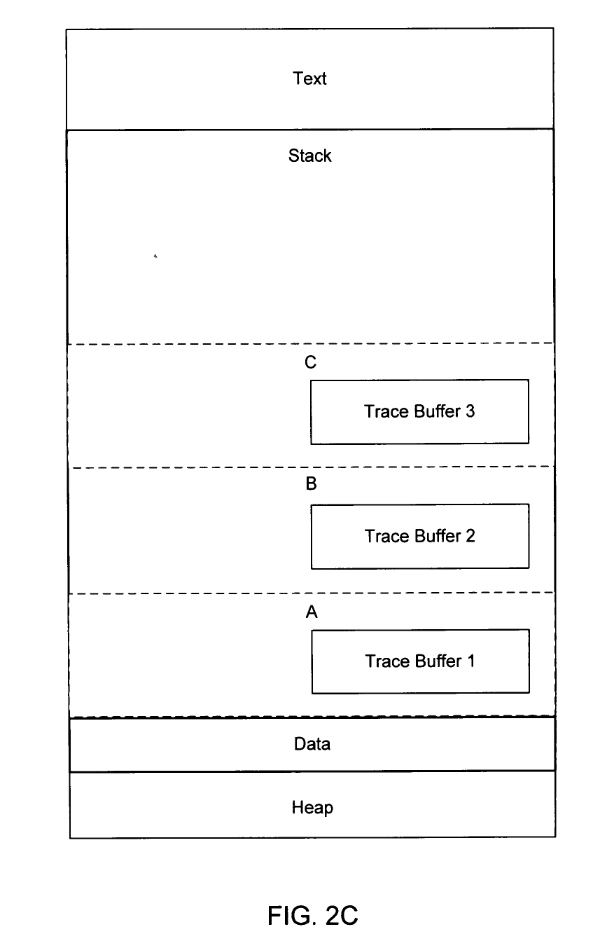

FIG. 2A is a schematic diagram depicting a method for performing compiler-inserted predicated tracing in accordance with an embodiment of the invention. A running instrumented program 202 is shown. The program 202 includes text, stack, data and heap sections, along with a trace buffer 204.

In accordance with the embodiment shown in FIG. 2A, the trace buffer 204 may be allocated on a per-process basis by the operating system at a well-defined start address in the data section of the process. In this embodiment, the trace buffer 204 is visible to and accessible by that process only. This embodiment enables tracing information to be collected on a per-process basis.

In an alternate embodiment, depicted in FIG. 2B, the trace buffer 204 may be allocated at a well-defined start address in global memory 221 by the operating system. In this embodiment, the trace buffer is visible to and accessible by all processes. This embodiment allows for monitoring of system behavior.

In another alternate embodiment, depicted in FIG. 2C, the trace buffer 204 may be allocated in each activation record (i.e. each routine executing on the stack), and then it gets deallocated automatically when the routine is exited. For example, FIG. 2C shows an example with three routines (A, B and C). Within each routine, there is a trace buffer (1, 2, and 3, respectively). In most cases, the trace routine may determine the location of the start of the trace buffer by referencing the frame pointer of the calling routine. In this embodiment, memory is efficiently used, and the trace data is collected only for those routines currently executing on the stack at the time of failure.

Data may be inserted into the trace buffer 204 by calling trace routines 206. The trace routines may be configured to record the caller address (identified in scratch register b7, for example) into the trace buffer 204, and then increment a buffer pointer, applying wrapping logic as needed. Because predicated trace calls are “artificially” injected into code, the trace routines should be configured carefully with safety mechanisms so as not to overwrite registers and memory locations which may be “live” at the trace call site. Even with these safety mechanisms in place, the trace routines may be implemented in a very lightweight manner because of the large register set of the Itanium™ architecture.

An auxiliary software tool (named, for example, “PTRACE”) 208 may be used to start or stop trace collection. PTRACE may be configured to attach to the instrumented process and to extract the trace data therefrom 210. In accordance with one embodiment, attaching to processes executing system code may not always be possible because breakpoints may not be allowed when interrupts are masked. In such situations, the auxiliary tool (“PTRACE”) may continue its request to attach to the process until it eventually succeeds.

More particularly, PTRACE 208 may be configured to attach to the instrumented process, hold the instrumented process in debug mode, set or unset the guarding predicate registers to enable or disable tracing, respectively, and to extract data from the trace buffer. PTRACE may be configured to subsequently detach from the instrumented process and allow the instrumented process to resume execution.

Thereafter, upon a system crash 212, a core file 214 for the instrumented process will be written out (i.e. “dumped”). A debugger tool 216 may then be utilized to access the trace buffer directly so as to retrace the execution 218. As discussed above, retracing execution is a valuable capability for low-level debugging purposes.

In addition, the auxiliary tool (“PTRACE”) may be configured to periodically aggregate data from the trace buffer. This may be done by periodically reading the trace buffer from memory and storing the data to disk while the instrumented process is held in debug mode. In this way, the predicated tracing may be used for system monitoring, in addition to or alternatively to its use for debugging.

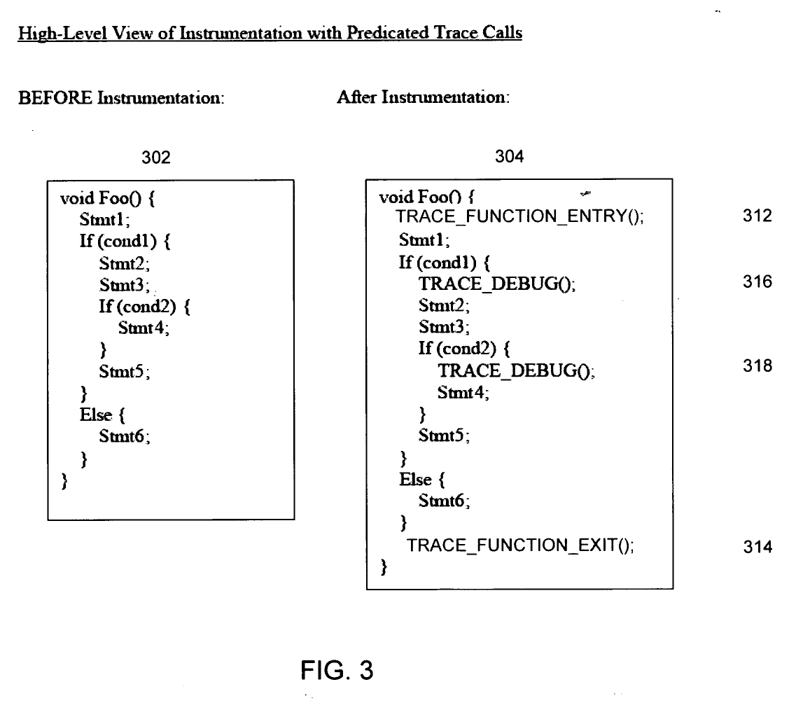

FIG. 3 depicts a high-level view of example program code before 302 and after 304 insertion of instrumentation for predicated trace calls in accordance with an embodiment of the invention. Shown in the example code are a predicated call to a trace monitor entry procedure (“TRACE_FUNCTION_ENTRY( )”) 312 and a predicated call to a trace monitor exit procedure (“TRACE_FUNCTION_EXIT( )”) 314. Also shown are predicated calls to a trace debug procedure (“TRACE_DEBUG( )”) 316 and 318 at control flow decision points.

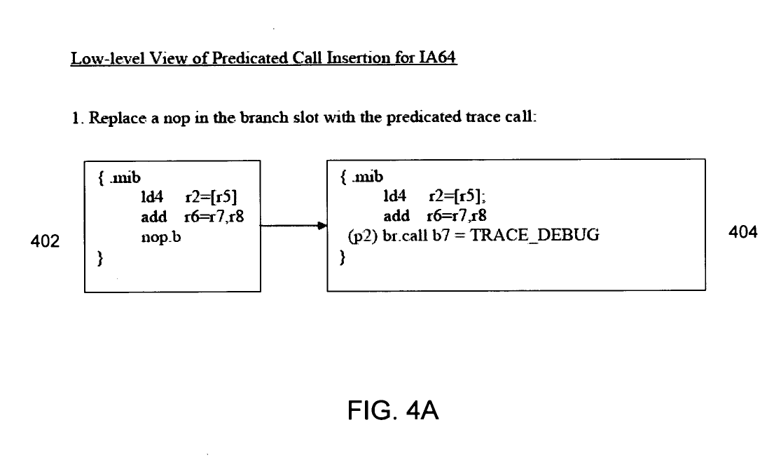

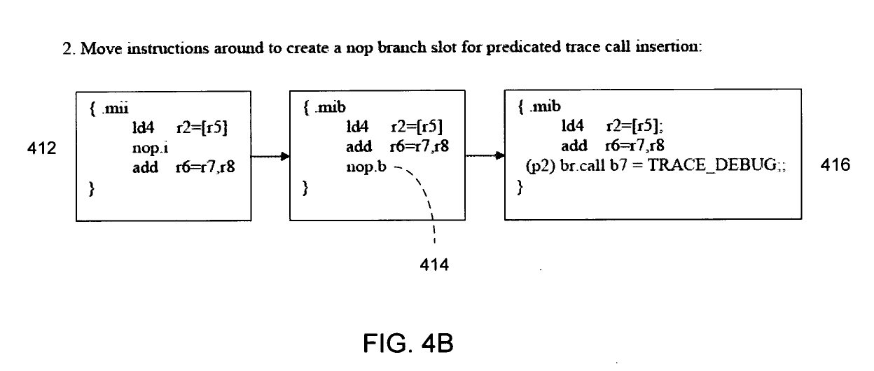

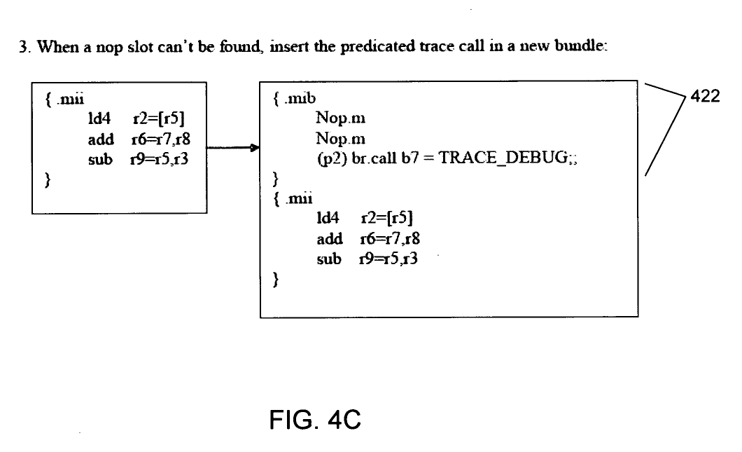

FIG. 4A depicts predicated call insertion by replacing a no operation (nop) instruction in a branch slot in accordance with an embodiment of the invention. The example program code before the replacement shows the nop instruction (“nop.b”) in a branch slot 402. This nop instruction is replaced by a predicated trace call (“(p2) br.call b7=TRACE_DEBUG”) 404.

FIG. 4B depicts moving instructions around to create a nop branch slot for predicated trace call insertion in accordance with an embodiment of the invention. The example program code before the replacement shows the nop instruction not in a branch slot (“nop.i”) 412. This nop instruction is moved to a branch slot (“nop.b”) 414, and then it is replaced by a predicated trace call (“(p2) br.call b7=TRACE_DEBUG”) 416.

FIG. 4C depicts inserting a predicated trace call in a new bundle in accordance with an embodiment of the invention. The example program code before the insertion is shown on the left side, and the code after the insertion is shown on the right side. The inserted code 422 is a new bundle of code comprising a predicated trace call.

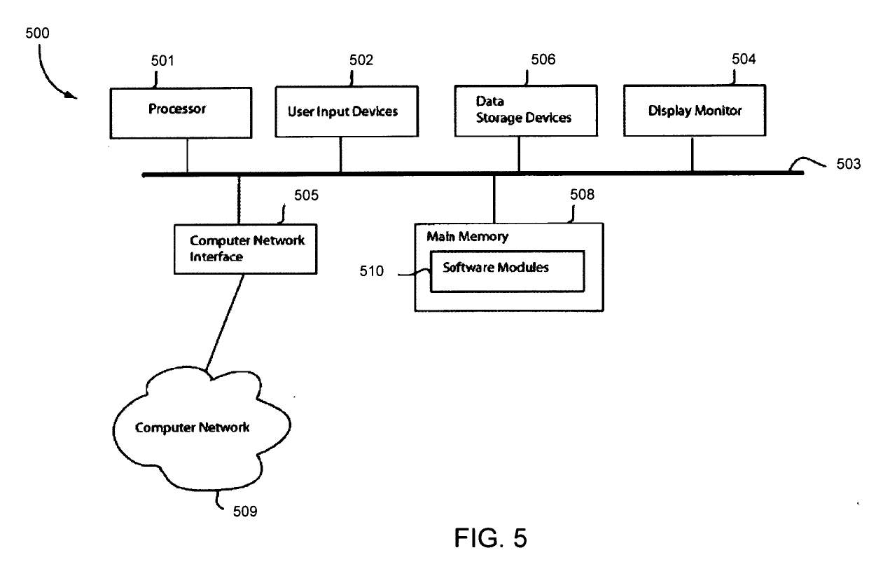

FIG. 5 is a schematic diagram of an example computer system or apparatus 500 which may be used to execute the computer-implemented procedures in accordance with an embodiment of the invention. The computer 500 may have less or more components than illustrated. The computer 500 may include a processor 501, such as those from the Intel Corporation or Advanced Micro Devices, for example. The computer 500 may have one or more buses 503 coupling its various components. The computer 500 may include one or more user input devices 502 (e.g., keyboard, mouse), one or more data storage devices 506 (e.g., hard drive, optical disk, USB memory), a display monitor 504 (e.g., LCD, flat panel monitor, CRT), a computer network interface 505 (e.g., network adapter, modem), and a main memory 508 (e.g., RAM).

In the example of FIG. 5, the main memory 508 includes software modules 510, which may be software components to perform the above-discussed computer-implemented procedures. The software modules 510 may be loaded from the data storage device 506 to the main memory 508 for execution by the processor 501. The computer network interface 505 may be coupled to a computer network 509, which in this example includes the Internet.

Predicated tracing was tested by the applicant on an HP Integrity NonStop™ server. For testing purposes, a compiler itself was instrumented with predicated calls. An init routine (routine that executes before the main entry point is called) was created to initialize p2 and p3 to 0, and to allocate a 1.5 GB buffer starting at a predetermined address. A stress-test C program was used as input for the instrumented compiler. First, verification was made that the compiler behaved normally when tracing was disabled—the test case compiled in the expected time, producing the expected object file. The compiler was then run again, and PTRACE was used to enable tracing midway through compilation. Verification was made that the trace buffer was continuously populated with new code addresses. Lastly, a test was conducted which involved forcing the instrumented compiler to fail hard with a segmentation fault while predicated tracing was on. The generated core file was examined in a debugger. From the trace information, the path taken to the failure point was easily identifiable, and it was readily determinable how the register being de-referenced came to have a NULL value.

In this particular test, the instrumented compiler performed slower when tracing was enabled compared to when tracing was disabled. Applicants believe that, in this particular case, this was due to an increase in the number of page faults associated with the large memory footprint of the trace buffer. These page faults may be reduced or eliminated by configuring the operating system to always keep the trace buffer resident in memory. Also, buffer management techniques may be used to reduce the page faults. For example, if the predetermined address to insert the trace buffer is the same as that of a previously inserted trace buffer, then the insertion may be ignored, or insert counts may be used to track duplicate calls.

Advantageously, the predicate tracing technique disclosed herein exhibits a negligible probe effect when tracing is disabled. This is a substantial advantage because deployed applications are meant to run optimally or near optimally (and hence with tracing disabled). This contrasts with existing static solutions, especially when thousands of trace calls are inserted at a sufficiently fine granularity across the application to support low-level debugging.

The predicated tracing technique has advantages over dynamic tracing facilities as well. First, predicated tracing is a very lightweight solution that is both easy to implement and to operate. There are no operating system dependencies, no application code changes needed, and the solution may be easily ported to another processor which supports hardware predication. In contrast, solutions such as DTRACE have an extensive, heavy infrastructure in place, and are tied intimately with the operating system, which makes portability a real problem. Also, dynamic tracing requires that the code/text section of a process have write access. This allows for self-modifying code, which is a potentially serious security issue. For operating systems that do not support write access by the code/text section (for example, fault-tolerant NonStop systems by the Hewlett Packard Company), dynamic instrumentation would not work.

Predicated tracing is particularly well-suited for supporting low-level debugging of system crashes. Probe insertion at all control flow decision points by the predicated tracing technique typically results in thousands of trace calls. Dynamic instrumentation techniques would likely not be able to support so many trace calls due to limits being exceeded. Also, with techniques like DTRACE, these probes would have to be described and defined in a programming language specifically designed for DTRACE. In contrast, with the predicated tracing technique, the compiler automatically inserts the trace calls, leaving guesswork by the programmer behind, and avoiding user errors while achieving comprehensive coverage of the application.

Another advantageous aspect of some embodiments of the predicated tracing technique relates to performance when tracing is enabled. Predicated trace calls themselves are very rapid because i) they simply write an address to a trace buffer, and ii) the instrumented application and the trace routines themselves are statically bound together, making the call sequence very fast. In contrast, with dynamic instrumentation, if you factor in the number of probe points added across the application at every critical point, the call sequence overhead would be too costly to implement. Additionally, dynamic instrumentation techniques generally increase code size at run time—this may change program behavior, resulting in slower (non-optimized) performance. Hence, predicated tracing has an additional advantage of high performance when a deployed program is being traced.

Finally, because the predicated tracing technique disclosed herein is a compiler-based solution, static analysis may be used to construct trace routine which record values of variables in the trace buffer at various execution points. The compiler may track which variables are in which registers at which locations in the generated code. At the very least, entry arguments and return values may be recorded. This information may be used to help complete the view of what the dynamic execution trace looked like at the point of failure. This view may not be easily constructed with dynamic instrumentation because only the compiler maintains this information.

In the above description, numerous specific details are given to provide a thorough understanding of embodiments of the invention. However, the above description of illustrated embodiments of the invention is not intended to be exhaustive or to limit the invention to the precise forms disclosed. One skilled in the relevant art will recognize that the invention can be practiced without one or more of the specific details, or with other methods, components, etc. In other instances, well-known structures or operations are not shown or described in detail to avoid obscuring aspects of the invention. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the claims. Rather, the scope of the invention is to be determined by the following claims, which are to be construed in accordance with established doctrines of claim interpretation.

What is claimed is:

1. A computer-implemented method of generating an executable program, the method comprising:
receiving by a compiler at least one source file having source code therein;
inserting predicated calls to trace routines during compilation of the source code, wherein each predicated call comprises a function call that is conditional upon a value stored in a predicate register; and
linking object code generated from compiling said source code with object code which includes the trace routines.

2. The computer-implemented method of claim 1, wherein said predicated calls to the trace routines are executed if the value stored in the predicate register is true, but not if the value stored in the predicate register is false.

3. The computer-implemented method of claim 1, wherein the predicated calls are inserted into the trace routines after code optimizations are performed and before object file generation.

4. The computer-implemented method of claim 1, wherein said trace routines include a trace function procedure for tracing a function that is dynamically executed.

5. The computer-implemented method of claim 1, wherein said trace routines include a trace debug procedure for tracing a path taken during execution of the program, and wherein predicated calls to the trace debug procedure are inserted at control flow decision points.

6. The computer-implemented method of claim 5, further comprising:
replacing a no operation instruction at a branch slot with a predicated call to the trace debug procedure.

7. The computer-implemented method of claim 6, further comprising:
moving at least one instruction so as to position the no operation position at the branch slot.

8. A computer-implemented method of executing a deployed computer program with low-level tracing using compiler-inserted predicated tracing calls, the method comprising:
enabling a tracing mode by setting one or more predicate register bits in a microprocessor;
performing predicated calls to trace routines which insert trace data into at least one trace buffer; and
writing out a core file including said trace data upon a system crash.

9. The method of claim 8, wherein enabling the tracing mode is performed by an auxiliary software tool attaching to a process of the deployed computer program and setting said one or more predicate register bits.

10. The method of claim 8, wherein a trace buffer comprises a rotating buffer starting at a predetermined memory address.

11. The method of claim 8, wherein a trace buffer is allocated on a memory stack within a routine.

12. The method of claim 8, wherein said trace routines include a trace debug procedure for tracing a path taken during execution of the program, and wherein predicated calls to the trace debug procedure are positioned at control flow decision points.

13. A computer apparatus configured to execute a deployed computer program with low-level tracing using compiler-inserted predicated tracing calls, the apparatus comprising:
a processor for executing computer-readable program code;
memory for storing in an accessible manner computer-readable data;
computer-readable program code configured to enable a tracing mode by setting one or more predicate register bits in a microprocessor;
computer-readable program code configured to perform predicated calls to trace routines which insert trace data into at least one trace buffer; and
computer-readable program code configured to write out a core file including said trace data upon a system crash.

14. The computer apparatus of claim 13, further comprising:
computer-readable program code configured to enable the tracing mode by attaching to a process of the deployed computer program and setting said one or more predicate register bits.

15. The computer apparatus of claim 13, wherein a trace buffer comprises a rotating buffer starting at a predetermined memory address.

16. The computer apparatus of claim 13, wherein a trace buffer is allocated on a memory stack within a routine.

17. The computer apparatus of claim 13, wherein said trace routines include a trace debug procedure for tracing a path taken during execution of the program, and wherein predicated calls to the trace debug procedure are positioned at control flow decision points.

18. A computer apparatus configured to generate an executable program, the apparatus comprising:
a processor for executing computer-readable program code;
memory for storing in an accessible manner computer-readable data;
computer-readable program code configured as a compiler, wherein the at least one source file having source code therein is receivable by the compiler;
computer-readable program code configured to insert predicated calls to trace routines during compilation of the source code, wherein each predicated call comprises a function call that is conditional upon a value stored in a predicate register; and
computer-readable program code configured to link object code generated from compiling said source code with object code which includes the trace routines.

19. The computer apparatus of claim 18, wherein said predicated calls to the trace routines are executed if the value stored in the predicate register is true, but not if the value stored in the predicate register is false.

20. The computer apparatus of claim 18, further comprising:
computer-readable program code configured to perform code optimizations prior to insertion of the predicated calls to the trace routines.
